(19) United States
(12) Patent Application Publication
(10) Pub. No.: US 2002/0115762 A1
(43) Pub. Date: Aug. 22, 2002

(54) Polycarbonate resin composition containing titanium dioxide and sulfone sulfonate salt

(75) Inventors: Han-Soo Chung, Gyeonggi-do (KR); Hee-Goo Yea, Gyeonggi-do (KR)

Correspondence Address: Maria Parrish Tungol, Suite 100, 5820 Fifer Drive, Alexandria, VA, 22303, US

(73) Assignee: CHEIL INDUSTRIES, INC., Kyungbuk (KR)

(21) Appl. No.: 10/027,836

(22) Filed: Dec. 21, 2001

(30) Foreign Application Priority Data
Dec. 21, 2000 (KR) 2000-79633

(51) Int. Cl. C08J 3/00

(52) U.S. Cl. 524/161

(57) ABSTRACT

The polycarbonate resin composition having good reflectance and impact strength according to the present invention comprises (A) about 100 parts by weight of a thermoplastic polycarbonate resin as a base resin, (B) about 2-20 parts by weight of titanium dioxide, (C) about 0.01-5 parts by weight of at least one sulfone sulfonate salt, and optionally (D) about 0-30 parts by weight of an impact modifier and optionally (E) about 0-30 parts by weight of a vinyl copolymer, and optionally (F) about 0-1.0 parts by weight of a stilbene-bisbenzoxazole derivative.

### FIELD OF THE INVENTION

The present invention relates to polycarbonate resin compositions having excellent light reflectance and impact resistance. More particularly, the present invention relates to titanium dioxide-containing polycarbonate resin compositions which also contain at least one sulfone sulfonate salt.

### BACKGROUND OF THE INVENTION

In general, a liquid crystal display (LCD) is composed of an LCD panel portion and a backlight unit. The LCD panel portion is composed of a glass substrate, a transparent electrode, liquid crystal and a color filter, and the backlight unit is composed of a reflector for providing backlighting, a fluorescent lamp, a light guide panel, a diffusion sheet, a prism sheet and a backlight frame. The backlight unit is made of a polymer resin. The backlight unit should have high light reflectance to reflect the backlights without loss and good fluidity and impact strength to carry out effectively the function of the frame, and have a thin thickness. In addition, the backlight unit should have good heat resistance, dimensional stability and flameproof resistance. Polycarbonate is an exemplary polymer material that has the above characteristics.

Polycarbonate resin has been widely used as an engineering plastic for automoiles and electrical appliances because the resin has good impact strength, self-extinguishing properties, dimensional stability, transparency, mechanical strength, and heat resistance. However, unlike other conventional impact resistant resins, the impact strength of the polycarbonate resin is sensitive to the molecular weight of the polycarbonate, circumstances of use, notch impact, residual stress, etc. Furthermore, because the polycarbonate resin has a lower fluidity than other thermoplastic resins, it requires a high molding temperature during the molding process. Accordingly the high temperature causes thermal degradation of the polycarbonate resin, resulting in reduction of the molecular weight. Also, in order to compensate for lower fluidity, high injection pressure and high injection speed have been applied to the resin in the injection molding process. This process provides a certain part of a molded article with significant residual stress. Thermal degradation and residual stress can deteriorate the impact strength of the molded article. In addition, the impact strength is affected by other factors such as use of the molded article at high temperature and exposure of the molded article to a chemical. In other words, under these circumstances, the impact strength deteriorates. Accordingly, the practical use of polycarbonate resin is narrowly limited.

To minimize loss of the backlights in an LCD, the polycarbonate resin is quite often applied to the backlight frame by coloring in pure white. To prepare such pure white polycarbonate resin with high reflectance, U.S. Pat. No. 5,837,757 discloses a flame retardant polycarbonate resin composition comprising a polycarbonate resin and a titanium oxide powder in a ration by weight of from 70/30 to 90/10 and containing a compound containing the stilbene-bisbenzoxazole group. However, the polycarbonate resin composition cannot provide a high reflectance of 90% or above. Further, the composition has shortcomings in big drop of heat resistance and impact strength, because the polycarbonate is degraded by the titanium oxide.

In Japanese Patent Laid-open No. 9-176471, the impact strength of a molded article is also greatly decreased because a large amount of titanium oxide degrades the polycarbonate resin. Japanese Patent Laid-open No. 7-242781 discloses a resin composition having an increased impact resistance by adding styrene or metacryl resin that contain a diene rubber, but the reflectance is decreased because the rubber is color-changed by a long time exposure at high temperature.

Accordingly, the present inventors have developed a new polycarbonate resin composition having good reflectance and appearance in pure white color by employing titanium dioxide, and adding at least one sulfone sulfonate salt which prevents decrease in impact strength. The resin compositions may also contain an optional impact strength reinforcing material to inhibit degradation of the polycarbonate resin.

### SUMMARY OF THE INVENTION

The polycarbonate resin composition having good reflectance and impact strength according to the present invention comprises (A) about 100 parts by weight of a thermoplastic polycarbonate resin as a base resin, (B) about 2-20 parts by weight of titanium dioxide, (C) about 0.01-5 parts by weight of a sulfone sulfonate salt or mixture of sulfone sulfonate salts, optionally (D) about 0-30 parts by weight of an impact modifier, (E) optionally about 0-30 parts by weight of a vinyl copolymer, and optionally (F) about 0-1.0 parts by weight of a stilbene-bisbenzoxazole derivative.

The present invention provides a polycarbonate resin composition having good reflectance by employing titanium dioxide and at least one sulfone sulfonate salt. The compositions according to the present invention have excellent light reflectance, good impact strength, and high fluidity and can be used in the reflector or frame of the backlight unit of liquid crystal displays for notebook computers, monitors, television sets, camcorders and digital cameras. The resin composition is particularly useful for the production of a backlight frame of an LCD.

Another feature of the present invention is the provision of a polycarbonate resin composition having good impact strength by containing a polycarbonate resin, titanium dioxide, at least one sulfone sulfonate salt and optionally an impact strength reinforcing material, a vinyl copolymer, and/or a stilbene-bisbenzoxazole derivative.

These and other features and advantages of the present invention will be apparent from the ensuing disclosure.

### DETAILED DESCRIPTION OF THE INVENTION

(A) Polycarbonate Resin

The polycarbonate resin for use in this invention is known in the art such as in U.S. Pat. No. 5,837,757, herein incorporated by reference. The polycarbonate resin can be prepared by conventional methods which are well known to an ordinary skilled person in the art. The use of such a resin in a thermoplastic resin composition is also well known.

The polycarbonate resin (A) in the present invention is prepared by reacting a diphenol represented by the following formula (I) with a phosgene, a halogen formate or a carboxyldiester:

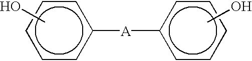

wherein A is C₁-C₅ alkylene, C₁-C₅ alkylidene, C₅-C₆ cycloalkylidene, S or SO₂ conjugated by a single bond.

The diphenols represented by the formula (I) include hydroquinone, resorcinol, 4,4ó-dihydroxydiphenyl, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane etc. Bisphenols such as 2,2′-bis(4-hydroxyphenyl)propane, 1,1-bis(4-hydroxyphenyl)cyclohexane, and 2,2-bis(3,5-dichloro-4-hydroxyphenyl)propane are preferred and 2,2-bis(4-hydroxyphenyl)propane called “Bisphenol A” is most preferred.

The weight average molecular weight of the polycarbonate resin (A) of the present invention is preferably about from 10,000 to 200,000, and more preferably about from 15,000 to 80,000. Polycarbonates useful in the present invention may be branched in a known manner, namely by the incorporation of 0.05 to 2 mol %, relative to the total amount of diphenols used, of trifunctional or greater than trifunctional compounds, for example such compounds with three or more phenolic groups. Further, an aromatic polyester-carbonate resin that is prepared by polymerization in the presence of an ester precursor such as difunctional carboxylate may be replaced for some or all of the polycarbonate resin.

In the present invention, the polycarbonate resin may be a homopolymer or a copolymer of diphenols, or mixtures thereof.

Further, an aromatic polyester-carbonate resin that is prepared by polymerization in the presence of an ester precursor such as difunctional carboxylate may be used in place of some or all of the polycarbonate resin.

The polycarbonate resin is used in the amount of about 100 parts by weight as a base resin.

(B) Titanium Dioxide

Various types of titanium dioxide are known in the art. Titanium dioxide is classified into Anatase type and Rutile type depending on crystallization. Titanium dioxide is classified into various types depending on shape of particle, surface treating agent to be used and average size of particle. Any type of titanium dioxide can be used in the present invention. However, it is preferable to use Rutile type with a median particle size of about 0. 15-0.25 to obtain good reflectance and mechanical properties.

The titanium dioxide is used in the amount of about 2-20 parts by weight, preferably about 8-12 parts by weight, per 100 parts by weight of the base resin (A)

(C) Sulfone Sulfonate Salt

The sulfone sulfonate salt for use in this invention include alkyl or aromatic sulfone sulfonate salts, and mixtures thereof. Suitable sulfone sulfonate salts are disclosed in U.S. Pat. No. 3,948,851, herein incorporated by reference. Alkali metal salts and alkali earth metal salts are preferably used. Sodium, lithium, potassium, rubidium, cesium, beryllium, magnesium, calcium, strontium or barium salts are suitable.

The sulfone sulfonate salt is represented by the following formula (II):

R′(SO₂)₁₋₂R″(SO₃M)₁₋₆X₀₋₁₁

where X is an electron withdrawing radical; M is an alkali or an alkali earth metal; and R′ and R″ are respectively an aryl radical having one or two of an aromatic ring or an aliphatic radical of C₁-C₆, and may be the same or different. Suitable X radicals include halo, nitro, trihalomethyl, and cyano radicals. Aromatic sulfone sulfonate salts are preferred.

Sulfone sulfonate salts that can be used in the present invention include potassium diphenylsulfone-3-sulfonate, dipotassium diphenylsulfone-3,3′-disulfonate, potassium 4-chloro-3′-(trifluoromethyl)diphenylsulfone-3-sulfonate, sodium diphenylsulfone-3-sulfonate, sodium 4,4′-dibromodiphenylsulfone-3-sulfonate, disodium diphenylsulfone-3,3′-disulfonate and disodium 4,4′-dichlorodiphenylsulfone-3,3′-disulfonate.

The sulfone sulfonate salt is used in the amount of about 0.01-5 parts by weight, preferably about 0.05-2 parts by weight, most preferably about 0.05-0.5 parts by weight per 100 parts by weight of the base resin (A).

(D) Impact Modifier

The polycarbonate composition according to the present invention may optionally include a graft copolymer, an olefin copolymer or mixtures thereof as an impact strength reinforcing material also referred to as an impact modifier.

The graft copolymer useful as an impact modifier is prepared by polymerizing at least one monomer selected from the group consisting of an acrylate monomer or a silicone monomer, and then by grafting at least one monomer selected from the group consisting of a styrene, anαa-methylstyrene, a halogen- or alkyl-substituted styrene, an acrylonitrile, a methacrylonitrile, a C₁-C₈ alkyl acrylate, a C₁-C₈ alkyl methacrylate, a maleic anhydride, and a C₁-C₄ alkyl- or phenyl-substituted maleimide. The amount of the rubber is preferably from about 20 to 90 parts by weight per the graft copolymer. Preferably, a graft copolymer prepared by grafting styrene or acrylonitrile monomers onto silicon monomers is used.

Suitable examples of the acrylate monomers include propyl acrylate, butyl acrylate, 2-ethylhexyl acrylate, hexyl acrylate, and 2-ethylhexyl acrylate. In the acrylate rubber, a crosslinking agent such as ethylene-glycol dimethacrylate, propylene-glycol dimethacrylate, 1,3-butylene glycoldimethacrylate, 1,4-butylene glycoldimethacrylate, allyl methacrylate, and triallyl cyanurate may be used.

Examples of silicone monomers include cyclosiloxanes such as hexamethyl cyclotrisiloxane, octamethyl cyclotetrasiloxane, decamethyl cyclopentasiloxane, dodecamethyl cyclohexasiloxane, trimethyl triphenylcyclotrisiloxane, tetramethyl tetraphenyl cyclotetrasiloxane, and octaphenyl cyclotetrasiloxane. In the polymerization of the silicon monomer, a crosslinking agent may be employed such as trimethoxy methylsilane, triethoxy phenylsilane, tetramethoxy silane, and tetraethoxy silane.

The graft copolymer is prepared by a conventional process such as emulsion polymerization, suspension polymerization, solution polymerization or bulk polymerization which is well known to an ordinary skilled person in the art. Preferably, emulsion or bulk polymerization is employed by adding vinyl monomers to rubber polymers using an initiator.

An olefin copolymer suitable for use as an impact modifier can be prepared by at least one olefin monomer selected from the group consisting of ethylene, propylene, isopropylene, butylene, and isobutylene. The olefin copolymer is prepared by using a Zieger-Natta catalyst or a metallocene catalyst. For preparing an olefin copolymer with a desirable structure, it is preferable to use a metallocene catalyst. For improving the dispersability of the olefin copolymer in the polycarbonate, a functional monomer can be grafted onto the olefin copolymer to form functional groups. A maleic anhydride is preferably used as a functional monomer.

The impact modifier is used in the amount of about 0-30 parts by weight, preferably about 1-5 parts by weight per 100 parts by weight of the base resin (A).

(E) Vinyl Copolymer

A vinyl copolymer may optionally be included in the polycarbonate resin composition according to the present invention. The vinyl copolymer is prepared by polymerizing at least one unsaturated monomer selected from the group consisting of a styrene, an a-methylstyrene, a halogen- or alkyl-substituted styrene, an acrylonitrile, a methacrylonitrile, a C₁-C₈ alkyl acrylate, a C₁-C₈ alkyl methacrylate, a maleic anhydride, an alkyl- or phenyl-substituted maleimide of C₁-C₄, and the mixtures thereof. It is preferable to polymerize at least one monomer selected from the group consisting of a styrene, a methacrylate methyl ester, and an acrylonitrile.

The C₁-C₈ alkyl methacrylate are esters of a methacrylic acid, and a C₁-C₈ alkyl acrylate are esters of an acrylic acid. The C₁-C₈ alkyl methacrylate and C₁-C8 alkyl acrylate are monohydril alcohols of C₁-C₈ The examples of C₁-C₈ alkyl methacrylate include methacrylic acid methylester, methacrylic acid ethylester, and methacrylic acid propylester.

Vinyl copolymer suitable for use in the present invention are prepared by emulsion polymerization, suspension polymerization, solution polymerization or melt polymerization. It is preferable to use a vinyl copolymer with weight average molecular weight about from 15,000 to 200,000.

Mixtures of vinyl copolymers may also be used. The vinyl copolymer is employed in the amount of about 0-30 parts by weight, preferably less than or equal to about 3 parts by weight per 100 parts by weight of the base resin (A).

(F) Stilbene-bisbenzoxazole Derivative

The stilbene-bisbenzoxazole derivatives can optionally be used in the compositions according to the invention and function to increase the reflectance of the polycarbonate resin composition. Examples of the stilbene-bisbenzoxazole derivatives include 4-(benzoxazole-2-yl)-4′-(5-methylbenzoxazole-2-yl) stilbene of the following formula (III) and 4,4′-bis(benzoxazole-2-yl) stilbene of the following formula (IV):

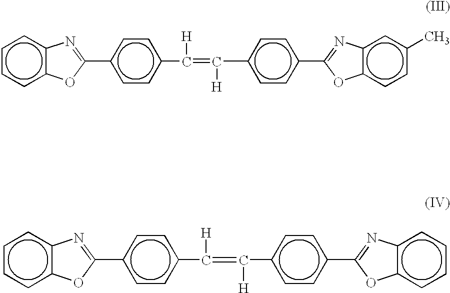

The stilbene-bisbenzoxazole derivative can be used together with a pigment such as blue and violet in an appropriate amount. A commercial product can be used. The stilbene-bisbenzoxazole derivative is used in the amount of about 0-1.0 parts by weight, preferably about 0.01-0.3 parts by weight, and most preferably 0.01-0.05 parts by weight as per 100 parts by weight of the base resin (A).

The polycarbonate resin composition according to the present invention may include additives such as an inorganic filler, an ultraviolet stabilizer, a heat stabilizer, an antioxidant, a flame retardant, a lubricant, a pigment, a dye and the mixtures thereof in order to improve the physical properties such as mechanical strength and heat distortion temperature. Preferred examples of the inorganic filler are glass fiber, carbon fiber, talc, silica, mica, alumina etc.

The resin composition according to the present invention is prepared in a form of pellet by extruding the blend with a conventional extruder.

The invention is illustrated in the following Examples which are intended for the purpose of illustration and are not to be construed as in any way limiting the scope of the present invention.

### EXAMPLES

Components (A) polycarbonate resin, (B) titanium dioxide, (C) sulfone sulfonate salt, (D1) graft copolymer resin 1, (D2) graft copolymer resin 2, (E) styrene-acrylonitrile (SAN) copolymer, and (F) stilbene-bisbenzoxazole derivative in Examples 1-8 and Comparative Examples 1-4 are described as follows:

(A) Polycarbonate resin

A “Bisphenol A” type linear polycarbonate was used. The weight average molecular weight is about from 20,000 to 30,000.

(B) Titanium Dioxide

Rutile titanium dioxide with a median particle size of about 0.15-0.25 mm was used.

(C) Sulfone Sulfonate Salt

A mixture of potassium diphenylsulfone-3-sulfonate and dipotassium diphenylsulfone-3,3 disulfonate in the ratio by weight of 75:25 was used. The content of diphenylsulfonate by product was less than 0.3% by weight.

(D) Impact Modifier

(D1) Graft copolymer resin 1

Graft copolymer resin 1 (SRK-200 (grade name) from Mitsubishi Rayon Co.) was prepared by grafting styrene and acrylonitrile monomers onto silicone rubber.

(D2) Graft copolymer resin 2

Twelve parts by weight of acrylonitrile and 33 parts by weight of styrene monomers were grafted onto 55 parts by weight of polybutadiene rubber latex with an average particle diameter of about 0.3 μm through a conventional emulsion process to prepare graft copolymer resin 2. The graft ratio of the copolymer is in the range of about 55%.

(E) Styrene-Acrylonitrile Copolymer (SAN copolymer)

Seventy parts by weight of styrene and 30 parts by weight of acrylonitrile were put into 120 parts by weight of deionized water, and 0.2 parts by weight of azobisisobutyronitrile and 0.5 parts by weight of tricalciumphosphate were added to the mixture. Styrene-acrylonitrile copolymer was prepared by suspension polymerization, followed by washing, dehydrating, and drying. The styrene-acrylonitrile copolymer was obtained in powder form.

F) Stilbene-bisbenzoxazole Derivative

The stilbene-bisbenzoxazole derivative used in these examples was 4-(benzoxazole-2-yl)-4′-(5-methylbenzoxazole-2-yl) stilbene. Pigment Blue was added to the stilbene-bisbenzoxazole derivative.

The amounts of the components used in Examples 1-8 and Comparative Examples 1-4 are shown in Table 1.

TABLE 1

| | Examples | | | | | | | | Comparative Examples | | | |
|---|---|---|---|---|---|---|---|---|---|---|---|---|
| Components | 1 | 2 | 3 | 4 | 5 | 6 | 7 | 8 | 1 | 2 | 3 | 4 |
| Polycarbonate | 100 | 100 | 100 | 100 | 100 | 100 | 100 | 100 | 100 | 100 | 100 | 100 |
| (A) | | | | | | | | | | | | |
| Titanium Dioxide | 10 | 10 | 10 | 10 | 10 | 10 | 10 | 10 | 10 | 10 | 10 | 10 |
| (B) | | | | | | | | | | | | |
| Sulfone sulfonate | 0.1 | 0.1 | 0.1 | 0.1 | 0.5 | 0.5 | 2 | 4 | — | — | — | — |
| salt (C) | | | | | | | | | | | | |
| Graft copolymer 1 | — | — | 5 | 5 | — | — | 5 | — | — | — | — | 5 |
| (D1) | | | | | | | | | | | | |
| Graft copolymer 2 | — | — | — | — | — | 5 | — | — | — | 5 | 5 | — |
| (D2) | | | | | | | | | | | | |
| SAN copolymer | — | — | — | 5 | — | 5 | 5 | — | — | 5 | 5 | 5 |
| (E) | | | | | | | | | | | | |
| Stilbene | — | 0.01 | 0.01 | 0.01 | — | — | 0.01 | 0.01 | — | — | 0.01 | 0.01 |
| derivative (F) | | | | | | | | | | | | |

As shown in Table 1, the components were blended, and then an antioxidant and a heat stabilizer were added and mixed. The resultant was fed into a twin-screw extruder of L/D 29 and Φ=45 mm. The resin compositions were prepared in pellet form by extruding the blend with the extruder.

The resultant pellets were dried at 110 for over 3 hours and were injection-molded. The test specimens (64 mm×12.7 mm×3.2 mm) for measuring Izod impact strength and the test specimens (127 mm×127 mm×2 mm) for observing falling impact were prepared. The Notched Izod impact strength for each Example and Comparative Example was tested in accordance with ASTM D256, and the reflectance was measured with injection-molded specimens (9 cm×5 cm) by using a spectrophotometer by Minolta Co. To measure the change of reflectance by heat, the reflectance was measured with the same specimens, after being at 100 for 500 hours, by using the same method. The Notched Izod impact strength and reflectances at different wavelengths for each Example and Comparative Example are shown in the following Table 2.

TABLE 2

| | Examples | | | | | | | | Comparative Examples | | | |
|---|---|---|---|---|---|---|---|---|---|---|---|---|
| | 1 | 2 | 3 | 4 | 5 | 6 | 7 | 8 | 1 | 2 | 3 | 4 |
| Notched Izod | 60 | 60 | 70 | 60 | 60 | 58 | 60 | 58 | 10 | 55 | 50 | 56 |
| Impact Strength | | | | | | | | | | | | |
| (kgf · cm/cm)(⅛″) | | | | | | | | | | | | |
| Reflectance (%) | | | | | | | | | | | | |
| At 450 mm | 90.6 | 99.0 | 99.1 | 99.5 | 90.7 | 91.2 | 99.6 | 99.3 | 80.4 | 83.6 | 95.4 | 96.1 |
| At 500 mm | 90.8 | 96.9 | 96.9 | 97.0 | 90.8 | 91.4 | 97.1 | 97.0 | 82.4 | 86.8 | 93.2 | 93.9 |
| At 550 mm | 91.0 | 96.0 | 96.0 | 96.2 | 91.3 | 91.8 | 96.4 | 96.2 | 85.5 | 89.0 | 89.2 | 89.9 |
| At 600 mm | 91.7 | 96.0 | 96.1 | 96.5 | 91.8 | 92.3 | 96.6 | 96.3 | 86.8 | 90.7 | 90.5 | 91.1 |
| At 650 mm | 91.9 | 96.5 | 96.5 | 96.5 | 92.0 | 92.4 | 96.7 | 96.5 | 87.3 | 91.9 | 91.4 | 92.0 |
| At 700 mm | 92.9 | 97.1 | 97.1 | 97.0 | 92.9 | 93.2 | 97.1 | 97.0 | 88.7 | 92.9 | 92.5 | 93.2 |
| Lowest | 90.6 | 96.0 | 96.0 | 96.2 | 90.8 | 91.2 | 96.4 | 96.2 | 80.4 | 83.6 | 89.2 | 89.9 |
| Reflectance | | | | | | | | | | | | |
| Reflectance after | | | | | | | | | | | | |
| 500 hrs at 100° C. | | | | | | | | | | | | |
| (%) | | | | | | | | | | | | |
| At 450 mm | 89.6 | 96.0 | 96.2 | 96.5 | 89.8 | 89.8 | 96.3 | 96.1 | 79.2 | 78.5 | 85.1 | 86.0 |
| At 500 mm | 89.7 | 95.9 | 96.1 | 96.5 | 89.9 | 89.9 | 96.4 | 96.2 | 81.5 | 81.6 | 86.3 | 87.2 |
| At 550 mm | 90.1 | 95.5 | 95.7 | 96.0 | 90.3 | 90.3 | 95.8 | 95.5 | 84.7 | 84.8 | 85.5 | 86.5 |
| At 600 mm | 90.7 | 95.8 | 95.9 | 96.2 | 90.8 | 90.8 | 96.0 | 95.8 | 86.2 | 86.7 | 86.6 | 87.5 |
| At 650 mm | 91.0 | 96.0 | 96.2 | 96.3 | 91.2 | 91.2 | 96.1 | 96.0 | 87.0 | 87.6 | 87.7 | 88.7 |
| At 700 mm | 92.1 | 96.5 | 96.8 | 96.8 | 92.3 | 92.3 | 96.5 | 96.3 | 88.1 | 89.2 | 89.3 | 90.2 |
| Lowest | 89.6 | 95.5 | 95.7 | 96.0 | 89.8 | 89.8 | 95.8 | 95.5 | 79.2 | 78.5 | 85.1 | 86.0 |
| Reflectance | | | | | | | | | | | | |

As shown in Table 2, the resin compositions of Comparative Examples 1-4 which do not contain sulfone sulfonate salt (C) show large drops in impact strength and much lower reflectances than the compositions of Examples 1-8.

It is apparent from the above that many modifications and changes and use of equivalent components and amounts are possible without departing from the spirit and scope of the present invention.

What is claimed is:

1. A polycarbonate resin composition comprising: (A) about 100 parts by weight of a thermoplastic polycarbonate resin as a base resin, (B) about 2-20 parts by weight of titanium dioxide, and (C) about 0.01-5 parts by weight of a sulfone sulfonate salt.

2. The polycarbonate resin composition of claim 1 wherein the amount of titanium dioxide is about 8-12 parts by weight per 100 parts by weight of the base resin (A).

3. The polycarbonate resin composition of claim 1 wherein said titanium dioxide is Rutile titanium dioxide with a median particle size of about 0.15-0.25 mm.

4. The polycarbonate resin composition of claim 1 wherein said sulfone sulfonate salt is an aromatic or alkyl sulfone sulfonate salt, or the mixture thereof.

5. The polycarbonate resin composition of claim 4 wherein said sulfone sulfonate salt is represented by the following formula (II):
R′(SO₂)₁₋₂R″(SO₃M)₁₋₆X₀₋₁₁
where X is halo, nitro, trihalomethyl, or cyano radical; M is an alkali or an alkali earth metal; and R′ and R″ are respectively an aryl radical having one or two aromatic rings or an aliphatic C₁-C₆ radical, wherein R′ and R″ are the same or different.

6. The polycarbonate resin composition according to claim 5 wherein the amount of sulfone sulfonate salt is about 0.05-2 parts by weight per 100 parts by weight of the base resin (A).

7. The polycarbonate resin composition according to claim 5 wherein the amount of sulfone sulfonate salt is about 0.05-0.5 parts by weight per 100 parts by weight of the base resin (A).

8. The polycarbonate resin compositions according to claim 5 wherein R′ and R″ are phenyl.

9. The polycarbonate resin composition according to claim 8 wherein the amount of sulfone sulfonate salt is about 0.05-2 parts by weight per 100 parts by weight of the base resin (A).

10. The polycarbonate resin composition according to claim 8 wherein the amount of sulfone sulfonate salt is about 0.05-0.5 parts by weight per 100 parts by weight of the base resin (A).

11. The polycarbonate resin compositions according to claim 1 wherein the sulfone sulfonate is potassium diphenylsulfone-3-sulfonate, dipotassium diphenylsulfone-3,3′-disulfonate, potassium 4-chloro-3′-(trifluoromethyl)diphenylsulfone-3-sulfonate, sodium diphenylsulfone-3-sulfonate, sodium 4,4′-dibromodiphenylsulfone-3-sulfonate, disodium diphenylsulfone-3,3′-disulfonate and disodium 4,4′-dichlorodiphenylsulfone-3,3′-disulfonate or a mixture thereof.

12. The polycarbonate resin composition according to claim 11 wherein the amount of sulfone sulfonate salt is about 0.05-2 parts by weight per 100 parts by weight of the base resin (A).

13. The polycarbonate resin composition according to claim 11 wherein the amount of sulfone sulfonate salt is about 0.05-0.5 parts by weight per 100 parts by weight of the base resin (A).

14. The polycarbonate resin composition of claim 13 wherein the amount of titanium dioxide is about 8-12 parts by weight per 100 parts by weight of the base resin (A).

15. The polycarbonate resin composition of claim 1 wherein said sulfone sulfonate salt is prepared by mixing potassium diphenylsulfone-3-sulfonate and dipotassium diphenylsulfone-3,3 disulfonate in the ratio by weight of 75:25.

16. The polycarbonate resin composition of claim 1 further comprising:
(D) about 0-30 parts by weight of an impact modifier obtained by polymerizing at least one monomer selected from the group consisting of acrylate monomers and silicone monomers, and then grafting thereon at least one monomer selected from the group consisting of a styrene, an a-methylstyrene, a halogen- or alkyl-substituted styrene, an acrylonitrile, a methacrylonitrile, a C₁-C₈ alkyl acrylate, a C₁-C₈ alkyl methacrylate, a maleic anhydride, and a C₁-C₄ alkyl- or phenyl-substituted maleimide, and the mixtures thereof.

17. The polycarbonate resin composition of claim 16 wherein said graft copolymer is prepared by grafting styrene and acrylonitrile monomers onto silicone monomers.

18. The polycarbonate resin composition of claim 1 further comprising:
(E) about 0-30 parts by weight of a vinyl copolymer obtained by polymerizing at least one monomer selected from the group consisting of a styrene, an a-methylstyrene, a halogen- or alkyl-substituted styrene, an acrylonitrile, methacrylonitrile, a C₁-C₈ alkyl acrylate, a C₁-C₈ alkyl methacrylate, a maleic anhydride, an alkyl- or phenyl-substituted C₁-C₄ maleimide, and the mixtures thereof.

19. The polycarbonate resin composition of claim 1 further comprising:
(F) about 0-1 parts by weight of a stilbene-bisbenzoxazole derivative per 100 parts by weight of the base resin (A).

20. The polycarbonate resin composition of claim 19 wherein said stilbene-bisbenzoxazole derivative is 4-(benzoxazole-2-yl)-4′-(5-methylbenzoxazole-2-yl) stilbene or 4,4′-bistbenzoxazole-2-yl) stilbene.

21. The polycarbonate resin composition of claim 1 further comprising an olefin polymer impact modifier prepared by polymerizing at least one olefin monomer selected from the group consisting of ethylene, propylene, isopropylene, butylene, and isobutylene or by grafting maleic anhydride onto the olefin polymer, or mixtures thereof.

22. The polycarbonate resin composition of claim 21 wherein the impact modifier is obtained by polymerizing at least one olefin monomer selected from the group consisting of ethylene, propylene, isopropylene, butylene, and isobutylene.

23. The polycarbonate resin composition of claim 21 wherein maleic anhydride is grafted on the olefin polymer.

24. A molded article prepared from the polycarbonate resin composition of claim 1.
